(19) United States
(12) Patent Application Publication
(10) Pub. No.: US 2025/0274059 A1
(43) Pub. Date: Aug. 28, 2025

(54) DRIVING MECHANISM

(71) Applicant: TDK Corporation, Tokyo (JP)

(72) Inventors: Pai-Jui CHENG, Taoyuan City (TW); Shu-Shan CHEN, Taoyuan City (TW); Chuan-Min LEE, Taoyuan City (TW)

(73) Assignee: TDK Corporation, Tokyo (JP)

(21) Appl. No.: 19/058,416

(22) Filed: Feb. 20, 2025

Related U.S. Application Data
(60) Provisional application No. 63/557,758, filed on Feb. 26, 2024.

(30) Foreign Application Priority Data
Apr. 30, 2024 (CN) 202420942976.X

(51) Int. Cl. H02N 2/02

(52) U.S. Cl. CPC H02N 2/025

(57) ABSTRACT

A driving mechanism is provided. The driving mechanism includes a fixed portion, a movable portion, and a driving portion. The movable portion is movable relative to the fixed portion. The driving portion is configured to drive the movable portion to move relative to the fixed portion. The movable portion and the driving portion are arranged along a first axis.

### CROSS REFERENCE TO RELATED APPLICATIONS

This application claims the benefit of U.S. Provisional Application No. 63/557,758, filed on Feb. 26, 2024 and China Patent Application No. 202420942976.X, filed on Apr. 30, 2024, the entirety of which are incorporated by reference herein.

### BACKGROUND OF THE INVENTION

### Field of the Disclosure

The present disclosure relates to a driving mechanism, and in particular it relates to a driving mechanism having a piezoelectric element.

### Description of the Related Art

As technology has developed, many of today's electronic devices (such as smartphones and digital cameras) have components such as motors to drive lenses or other objects. However, the displacement accuracy of conventional motors, such as stepper motors and voice coil motors, cannot meet certain specific requirements.

Therefore, how to design a driving mechanism that can improve displacement accuracy and achieve miniaturization are topics nowadays that need to be discussed and solved.

### BRIEF SUMMARY OF THE INVENTION

According to some embodiments of the disclosure, a driving mechanism is provided. The driving mechanism includes a fixed portion, a movable portion, and a driving portion. The movable portion is movable relative to the fixed portion. The driving portion is configured to drive the movable portion to move relative to the fixed portion. The movable portion and the driving portion are arranged along a first axis.

According to some embodiments, the driving mechanism further includes a contact member which is disposed on the movable portion. The contact member has a contact portion, configured to contact a driven element. The driving mechanism further includes a first flexible portion and a first connecting portion. The movable portion is movably connected to the fixed portion via the first flexible portion. The first connecting portion is connected to the driving portion, and the first connecting portion has a first connecting surface which faces the driving portion. The driving portion has a first surface which faces the first connecting portion and is connected to the first connecting surface.

According to some embodiments, the driving mechanism further includes a second connecting portion which is connected to the driving portion, and the second connecting portion has a second connecting surface which faces the driving portion. The driving portion has a second surface which faces the second connecting portion and is connected to the second connecting surface. The first connecting surface is perpendicular to the first axis. When viewed along a second axis, the first flexible portion does not overlap the driving portion. The first axis and the second axis are perpendicular to each other.

According to some embodiments, the first flexible portion and the driving portion are arranged along a third axis. The third axis, the first axis and the second axis are perpendicular to each other. The driving portion is configured to drive the movable portion to move in a first dimension, and movement in the first dimension at least includes movement along the second axis. When the driving portion drives the movable portion to move, the movement trajectory of the contact portion is an arc trajectory.

According to some embodiments, the arc trajectory has a closed structure. The arc trajectory has a center. The arc trajectory defines a central axis, which passes through the center. The central axis is parallel to the third axis. The central axis is perpendicular to the second axis. When viewed along the first axis or the third axis, the central axis does not pass through the center of the driving portion.

According to some embodiments, the first flexible portion has a first flexible portion surface and a second flexible portion surface. The first flexible portion surface and the second flexible portion surface face opposite directions. The first flexible portion further has a first notch and a second notch. The first notch is formed on the first flexible portion surface. The second notch is formed on the second flexible portion surface.

According to some embodiments, when viewed along the second axis, the first notch overlaps at least a portion of the second notch. The depth of the first notch is different from the depth of the second notch.

According to some embodiments, along the second axis, the maximum size of a first gap between the first flexible portion surface and a first end portion of the first notch is different from the maximum size of a second gap between the second flexible portion surface and a second end portion of the second notch. Along the second axis, the maximum size of the first gap is greater than the maximum size of the second gap. When viewed along the first axis or the third axis, the center of the driving portion is located between the second flexible portion surface and the contact portion.

According to some embodiments, the first flexible portion further has a first deformation portion which is adjacent to the first notch. The first deformation portion is adjacent to the second notch. The first deformation portion is located between the first notch and the second notch.

According to some embodiments, when viewed along the first axis, a first distance is defined between the center of the first deformation portion and the first flexible portion surface. When viewed along the first axis, a second distance is defined between the center of the first deformation portion and the second flexible portion surface. The first distance and the second distance have a first ratio. The first ratio is not equal to one.

According to some embodiments, the first flexible portion further has a third flexible portion surface and a fourth flexible portion surface. The third flexible portion surface is perpendicular to the first flexible portion surface. The fourth flexible portion surface and the third flexible portion surface face opposite directions. The first flexible portion further has a third notch and a fourth notch. The third notch is formed on the third flexible portion surface. The fourth notch is formed on the fourth flexible portion surface.

According to some embodiments, when viewed along the third axis, the third notch overlaps the fourth notch. The depth of the third notch is different from the depth of the fourth notch. The concave center line of the third notch extends along the third axis. The concave center line of the fourth notch does not extend along any one of the first axis, the second axis and the third axis.

According to some embodiments, along the third axis, the maximum size of a third gap between the third flexible portion surface and a third end portion of the third notch is different from the maximum size of a fourth gap between the fourth flexible portion surface and a fourth end portion of the fourth notch. Along the third axis, the maximum size of the third gap is greater than the maximum size of the fourth gap.

According to some embodiments, the third notch has a third arc surface. The fourth notch has a fourth arc surface. The radius of curvature of the third arc surface is different from the radius of curvature of the fourth arc surface. The radius of curvature of the third arc surface is less than the radius of curvature of the fourth arc surface. The shortest distance between the third arc surface and the driving portion is greater than the shortest distance between the fourth arc surface and the driving portion.

According to some embodiments, the first flexible portion has a second deformation portion which is adjacent to the third notch. The second deformation portion is adjacent to the fourth notch. The second deformation portion is located between the third notch and the fourth notch. When viewed along the second axis, a third distance is defined between the center of the second deformation portion and the third flexible portion surface. When viewed along the second axis, a fourth distance is defined between the center of the second deformation portion and the fourth flexible portion surface. The third distance and the fourth distance have a second ratio. The second ratio is not equal to one.

According to some embodiments, the first flexible portion has a fifth flexible portion surface. The fifth flexible portion surface is perpendicular to the first flexible portion surface. The fifth flexible portion surface and the first connecting surface face opposite directions. The first flexible portion has a fifth notch and a sixth notch. The fifth notch is formed on the fifth flexible portion surface. The sixth notch is formed on the fourth flexible portion surface.

According to some embodiments, when viewed along the first axis, the fifth notch overlaps at least a portion of the sixth notch. The depth of the fifth notch is different from the depth of the sixth notch. Along the first axis, the maximum size of a fifth gap between the fifth flexible portion surface and a fifth end portion of the fifth notch is different from the maximum size of a sixth gap between the first connecting surface and a sixth end portion of the sixth notch. Along the first axis, the maximum size of the fifth gap is greater than the maximum size of the sixth gap.

According to some embodiments, the fifth notch has a fifth arc surface. The sixth notch has a sixth arc surface. The radius of curvature of the fifth arc surface is different from the radius of curvature of the sixth arc surface. The radius of curvature of the fifth arc surface is less than the radius of curvature of the sixth arc surface. The shortest distance between the fifth arc surface and the driving portion is greater than the shortest distance between the sixth arc surface and the driving portion.

According to some embodiments, the sixth arc surface has a first arc surface portion and a second arc surface portion. The first arc surface portion faces the third arc surface. The second arc surface portion faces the fifth arc surface. The first arc surface portion and the second arc surface portion are integrally formed as one piece. The first flexible portion has a third deformation portion which is adjacent to the fifth notch. The third deformation portion is adjacent to the sixth notch. The third deformation portion is located between the fifth notch and the sixth notch. When viewed along the second axis, a fifth distance is defined between the center of the third deformation portion and the fifth flexible portion surface. When viewed along the second axis, a sixth distance is defined between the center of the third deformation portion and the first connecting surface. The fifth distance and the sixth distance have a third ratio. The third ratio is not equal to one.

According to some embodiments, the sixth notch is symmetrical to the fourth notch. The first notch, the fourth notch, the fifth notch and the sixth notch are integrally formed as one piece. When viewed along the second axis, the first flexible portion has a rectangular structure. The longitudinal axis of the rectangular structure is parallel to the first axis. The first flexible portion further has a notch portion, which is disposed at a corner of the rectangular structure. When viewed along the second axis, the fifth notch is located between the notch portion and the movable portion.

The present disclosure provides a driving mechanism, which includes a fixed assembly, a movable member and a driving assembly. The driving assembly is configured to drive the movable member to move relative to the fixed assembly. The driving assembly may include a driving body and a driving portion. The driving portion can receive external control signals and then deforms to push the driving body to deform, thereby driving the contact member located on the movable portion to move in the first dimension or the second dimension. When the contact member moves, the contact member will repeatedly contact the movable member, thereby driving the movable member to move, such as moving in the first direction or the second direction.

In some embodiments, the driving portion can drive the contact member to move clockwise or counterclockwise along an arc trajectory according to different control signals. Based on such a design, the driving member can quickly drive the movable member to move back and forth along the first axis, and the displacement accuracy can be greatly improved in contrast to a traditional motor. In addition, in other embodiments, by adjusting the configuration of the notches on the driving body, the driving portion can drive the contact member to move along the first axis or the second axis, thereby achieving different application purposes.

In addition, because the driving mechanism of the present disclosure does not require traditional coils, magnets and additional pushing elements, the overall volume of the driving mechanism can be effectively reduced to achieve the purpose of miniaturization, and because the driving portion is the piezoelectric element, it can provide a greater driving force than the traditional coil motor, so as to push a larger and heavier object.

Additional features and advantages of the disclosure will be set forth in the description which follows, and, in part, will be obvious from the description, or can be learned by practice of the principles disclosed herein. The features and advantages of the disclosure can be realized and obtained by means of the instruments and combinations pointed out in the appended claims. These and other features of the disclosure will become more fully apparent from the following description and appended claims, or can be learned by the practice of the principles set forth herein.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a perspective view of the driving mechanism 100 according to an embodiment of the present disclosure.

FIG. 2 is an exploded view of the driving mechanism 100 according to one embodiment of the present disclosure.

FIG. 3 is a cross-sectional view of the driving mechanism 100 along line A-A in FIG. 1 according to an embodiment of the present disclosure.

FIG. 4 is an exploded diagram of the driving assembly DA of the driving mechanism 100 according to an embodiment of the present disclosure.

FIG. 5 is a top view of the driving assembly DA according to an embodiment of the present disclosure.

FIG. 6 is a rear view of the driving assembly DA according to an embodiment of the present disclosure.

FIG. 7 is a side view of the driving assembly DA according to an embodiment of the present disclosure.

FIG. 8 to FIG. 10 are side views illustrating that the driving body 104 deforms to drive the contact member 105 to move and located in different positions according to an embodiment of the present disclosure.

FIG. 11 is a schematic diagram illustrating that the driving assembly DA drives the movable member 108 to move in a first direction D1 according to an embodiment of the present disclosure.

FIG. 12 is a schematic diagram illustrating that the driving assembly DA drives the movable member 108 to move in a second direction D2 according to an embodiment of the present disclosure.

FIG. 13 and FIG. 14 are side views illustrating that the movable portion 1041 drives the contact member 105 to be located in different positions according to another embodiment of the present disclosure.

FIG. 15 and FIG. 16 are side views illustrating that the movable portion 1041 drives the contact member 105 to be located in different positions according to another embodiment of the present disclosure.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are in direct contact, and may also include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may also include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

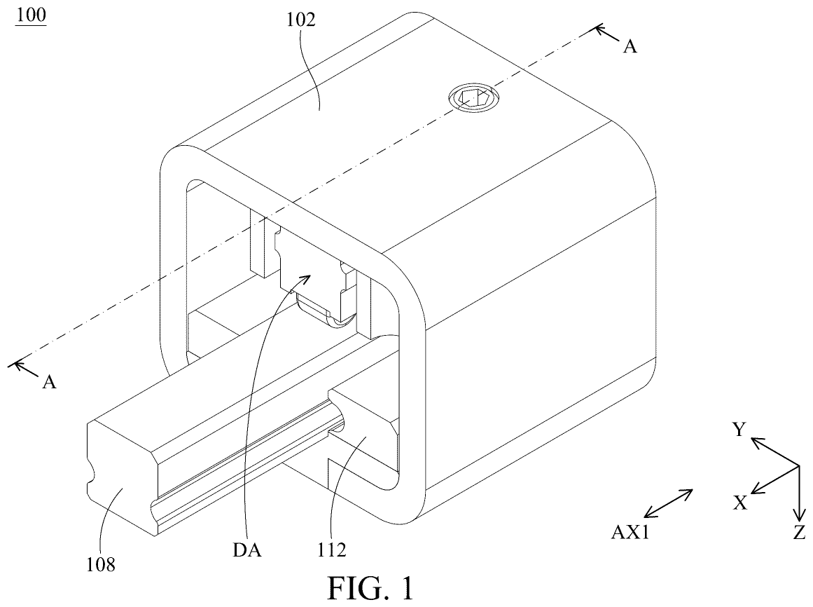

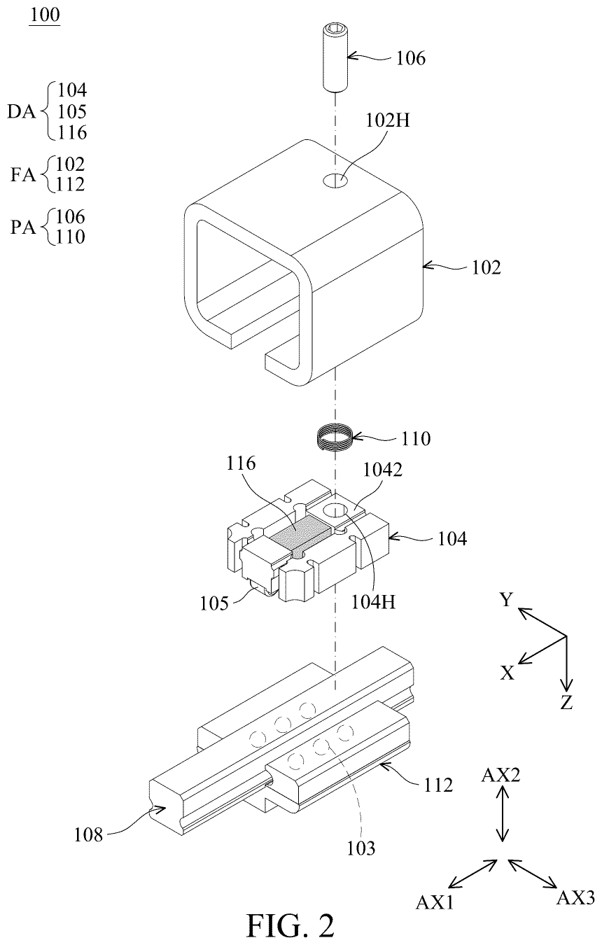

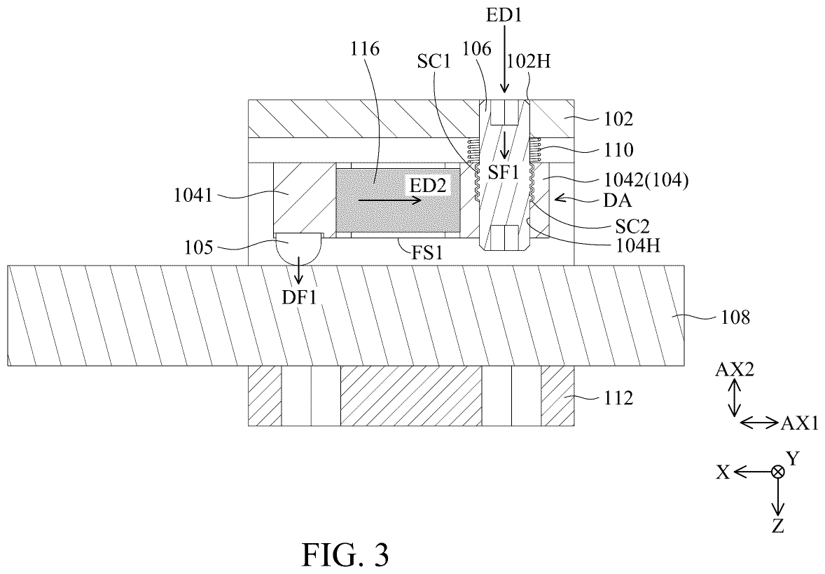

Please refer to FIG. 1 to FIG. 3. FIG. 1 is a perspective view of the driving mechanism 100 according to an embodiment of the present disclosure. FIG. 2 is an exploded view of the driving mechanism 100 according to one embodiment of the present disclosure, and FIG. 3 is a cross-sectional view of the driving mechanism 100 along line A-A in FIG. 1 according to an embodiment of the present disclosure. The driving mechanism 100 can be, for example, a driving linear motor configured to drive various components for linear movement. The driving mechanism 100 can carry larger weight components and can be applied to high-precision instruments such as 3D printers and electron microscopes.

In this embodiment, the driving mechanism 100 may include a fixed assembly FA, a movable member 108 and a driving assembly DA. The movable member 108 is movable relative to the fixed assembly FA. The driving assembly DA is configured to drive the movable member 108 to move along a first axis AX1 (the X-axis) relative to the fixed assembly FA. As shown in FIG. 1, when viewed along the first axis AX1, the driving assembly DA is located between the fixed assembly FA and the movable member 108.

In this embodiment, as shown in FIG. 2, the fixed assembly FA may include an outer casing 102 and a base 112, and the outer casing 102 is fixedly connected to the base 112 along a second axis AX2. The outer casing 102 and the base 112 can be made of metal or plastic material, and these two can be locked with screws or bonded with glue, but they are not limited thereto.

When viewed along the first axis AX1, the outer casing 102 and the base 112 surround the driving assembly DA. In addition, as shown in FIG. 2, the driving mechanism 100 further includes a plurality of rolling balls 103, which are arranged between the base 112 and the movable member 108, so that the movable member 108 can move relative to the base 112. It should be noted that the means of moving the movable member 108 relative to the base 112 is not limited to the rolling balls 103 in this embodiment.

In this embodiment, the driving assembly DA is connected to the outer casing 102. For example, as shown in FIG. 2 and FIG. 3, the driving mechanism 100 further includes a positioning assembly PA configured to be affixed to the driving assembly DA and the outer casing 102. In this embodiment, the positioning assembly PA may include a positioning member 106 and an elastic member 110.

The positioning member 106 may have a long strip-shaped structure. For example, the positioning member 106 can be a screw, but it is not limited thereto. The positioning member 106 passes through a hole 102H of the outer casing 102 and a first opening 104H of a fixed portion 1042 of the driving assembly DA to fix the driving assembly DA to the outer casing 102.

Specifically, as shown in FIG. 3, the positioning member 106 may have a first thread structure SC1, and a driving body 104 of the driving assembly DA may have a second thread structure SC2, corresponding to the first thread structure SC1. The first thread structure SC1 is configured to be screwed to the second thread structure SC2 so that the fixed portion 1042 of the driving body 104 is located in a fixed position in FIG. 3.

When viewed along a third axis AX3 (the Y-axis), as shown in FIG. 3, the positioning member 106 extends along a first extension direction ED1. When viewed along the third axis AX3, the driving body 104 extends along a second extension direction ED2. Due to tolerances, when the positioning member 106 fixes the driving body 104 to the outer casing 102, the first extension direction EDI may not be perpendicular to the second extension direction ED2.

Furthermore, the elastic member 110 is, for example, a spring, which is sheathes on the positioning member 106, but it is not limited thereto. As shown in FIG. 3, the elastic member 110 is disposed between the driving body 104 of the driving assembly DA and the outer casing 102, so that the elastic member 110 is configured to apply a stabilizing force SF1 onto the driving body 104 of the driving assembly DA.

Similarly, due to the aforementioned tolerances, the stabilizing force SF1 may be neither parallel nor perpendicular to a first flexible portion surface FS1 on the driving body 104. That is, the direction of the stabilizing force SF1 may not be perpendicular to the driving body 104.

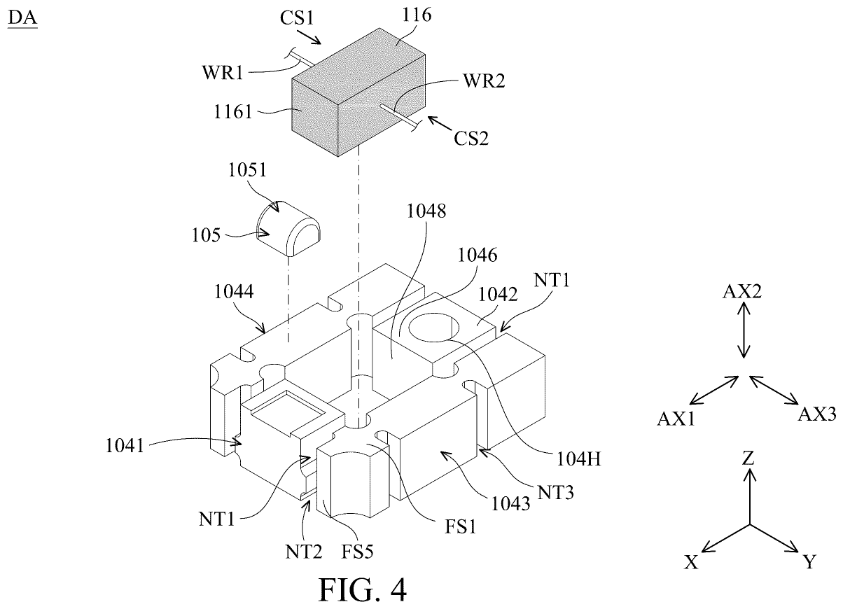

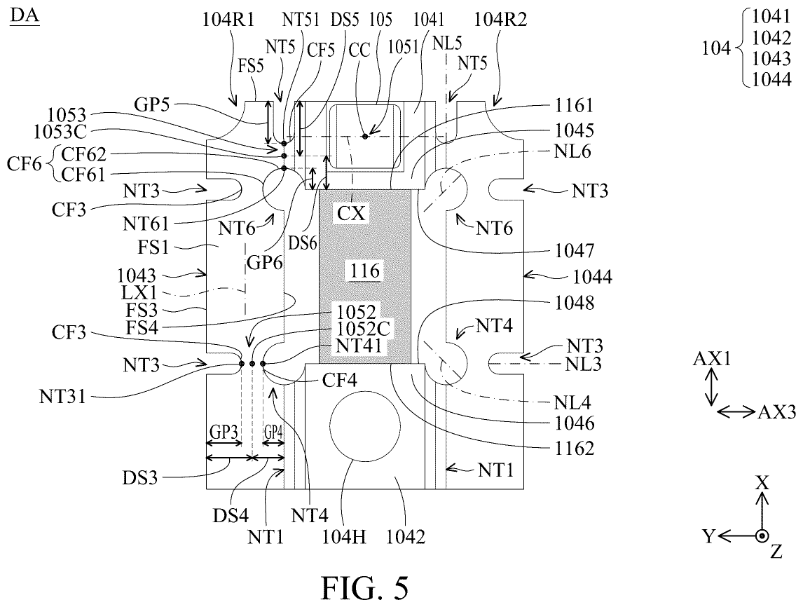

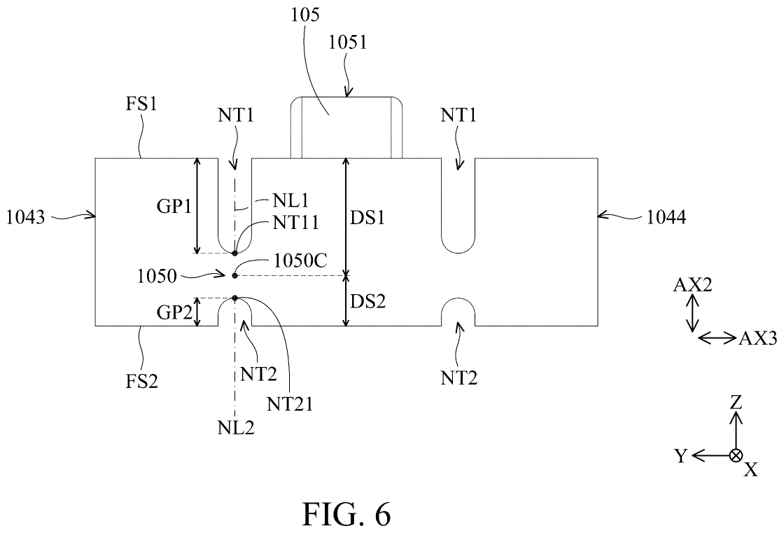

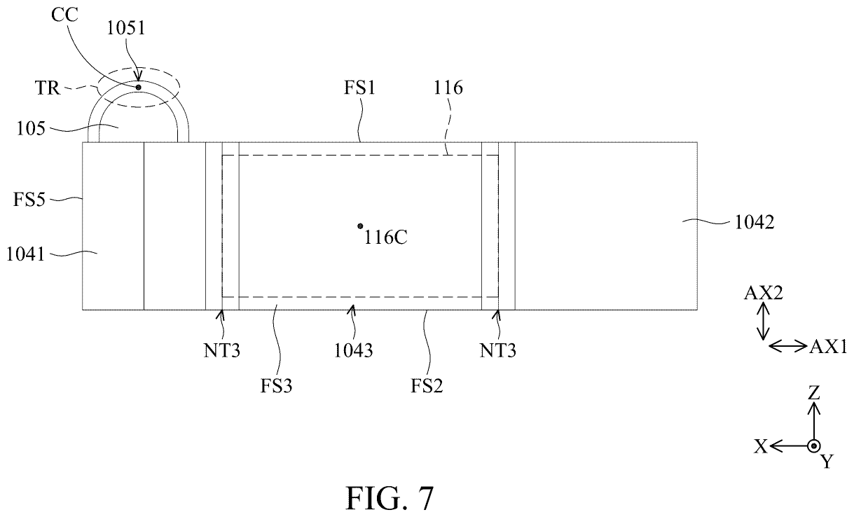

Next, please refer to FIG. 3 to FIG. 7. FIG. 4 is an exploded diagram of the driving assembly DA of the driving mechanism 100 according to an embodiment of the present disclosure, FIG. 5 is a top view of the driving assembly DA according to an embodiment of the present disclosure, FIG. 6 is a rear view of the driving assembly DA according to an embodiment of the present disclosure, and FIG. 7 is a side view of the driving assembly DA according to an embodiment of the present disclosure.

The driving assembly DA may include the aforementioned driving body 104 and a contact member 105. The driving body 104 has a flexible structure, and the contact member 105 is fixedly disposed on a movable portion 1041 of the driving body 104. In this embodiment, the driving body 104 can be made of a first metal material. For example, the first metal material may include stainless steel. Furthermore, the contact member 105 can be made of a second metal material, and the second metal material can include tool steel, for example, but the materials of the driving body 104 and the contact member 105 are not limited to this embodiment.

As shown in FIG. 3 and FIG. 4, the contact member 105 may have a semi-cylindrical structure, and the contact member 105 may have a contact portion 1051 configured to contact and apply a driving force DF1 to the movable member 108 (also called the driven element).

The contact portion 1051 is the part that contacts the movable member 108 (a portion of the arc surface in FIG. 4), and the direction of the aforementioned stabilizing force SF1 may not be perpendicular or parallel to the direction of the driving force DF1. Specifically, driving force DF1 may not be parallel to the Z-axis and may change direction as the contact member 105 moves.

Furthermore, as shown in FIG. 4 and FIG. 5, the driving body 104 may include the aforementioned fixed portion 1042 and the movable portion 1041, and the movable portion 1041 is movable relative to the fixed portion 1042. Furthermore, the driving body 104 further includes a first flexible portion 1043, and the movable portion 1041 is movably connected to the fixed portion 1042 via the first flexible portion 1043.

Similarly, the driving body 104 further includes a second flexible portion 1044, and the movable portion 1041 is movably connected to the fixed portion 1042 via the second flexible portion 1044. As shown in FIG. 5, the movable portion 1041 and the fixed portion 1042 are connected between the first flexible portion 1043 and the second flexible portion 1044.

Furthermore, the driving assembly DA may further include a driving portion 116 configured to drive the movable portion 1041 and the contact member 105 to move relative to the fixed portion 1042. The movable portion 1041 and the driving portion 116 are arranged along the first axis AX1 (the X-axis). In this embodiment, the driving portion 116 may be a piezoelectric element, such as being made of piezoelectric ceramics, but it is not limited thereto.

As shown in FIG. 5, the driving body 104 further includes a first connecting portion 1045, which is located on the movable portion 1041 and connected to the driving portion 116, and the first connecting portion 1045 has a first connecting surface 1047, which facing the driving portion 116. The driving portion 116 has a first surface 1161 facing the first connecting portion 1045 and connected to the first connecting surface 1047, such as by elastic glue.

Similarly, the driving body 104 may further include a second connecting portion 1046 which is connected to the driving portion 116, and the second connecting portion 1046 has a second connecting surface 1048 facing the driving portion 116. The driving portion 116 has a second surface 1162 facing the second connecting portion 1046 and connected to the second connecting surface 1048, such as by elastic glue. The first connecting surface 1047 and the second connecting surface 1048 are perpendicular to the first axis AX1.

It should be noted that in this embodiment, the first connecting portion 1045 and the first connecting surface 1047 are located on the movable portion 1041, and the second connecting portion 1046 and the second connecting surface 1048 are located on the fixed portion 1042, but they are not limited thereto. In other embodiments, the first connecting surface 1047 and the second connecting surface 1048 may be located on the inner surfaces of the first flexible portion 1043 and the second flexible portion 1044 respectively. That is, in other embodiments, the driving portion 116 may be connected between the first flexible portion 1043 and the second flexible portion 1044.

As shown in FIG. 5, when viewed along the second axis AX2 (the Z-axis), the first flexible portion 1043 and the second flexible portion 1044 do not overlap the driving portion 116, and the first axis AX1 and the second axis AX2 are perpendicular to each other. Furthermore, the first flexible portion 1043 and the driving portion 116 are arranged along the third axis AX3 (the Y-axis), and the third axis AX3, the first axis AX1 and the second axis AX2 are perpendicular to each other.

Furthermore, as shown in FIG. 5 to FIG. 7, the first flexible portion 1043 may have the aforementioned first flexible portion surface FS1 and a second flexible portion surface FS2, and the first flexible portion surface FS1 and the second flexible portion surface FS2 face opposite directions.

As shown in FIG. 7, when viewed along the first axis AX1 (the X-axis) or the third axis AX3 (the Y-axis), the center of the driving portion 116 is located between the second flexible portion surface FS2 and the contact portion 1051.

As shown in FIG. 5 and FIG. 6, the first flexible portion 1043 further has a first notch NT1 and a second notch NT2. The first notch NT1 is formed on the first flexible portion surface FS1, and the second notch NT2 is formed on the second flexible portion surface FS2.

When viewed along the second axis AX2, the concave center lines NL1 and NL2 of the first notch NT1 and the second notch NT2 both extend along the second axis AX2, the first notch NT1 overlaps at least a portion of the second notch NT2, and the depth of the first notch NT1 is different from the depth of the second notch NT2. In this embodiment, the depth of the first notch NT1 is greater than the depth of the second notch NT2, but they are not limited thereto.

It should be noted that the second flexible portion 1044 may also have a first notch NT1 and a second notch NT2 as well as other notch structures. That is, the second flexible portion 1044 and the first flexible portion 1043 are symmetrically configured (such as FIG. 5). Therefore, only the detailed structure of the first flexible portion 1043 will be described in the following paragraphs.

As shown in FIG. 6, along the second axis AX2, the maximum size of a first gap GP1 between the first flexible portion surface FS1 and a first end portion NT11 of the first notch NT1 is different from the maximum size of a second gap GP2 between the second flexible portion surface FS2 and a second end portion NT21 of the second notch NT2.

For example, in this embodiment, as shown in FIG. 6, along the second axis AX2, the maximum size of the first gap GP1 is greater than the maximum size of the second gap GP2, but it is not limited thereto.

Furthermore, in this embodiment, as shown in FIG. 6, the first flexible portion 1043 further has a first deformation portion 1050 which is adjacent to the first notch NT1, and the first deformation portion 1050 is also adjacent to the second notch. NT2. Specifically, the first deformation portion 1050 is a flexible portion of the driving body 104, which is located between the first notch NT1 and the second notch NT2.

As shown in FIG. 6, when viewed along the first axis AX1 (the X-axis), a first distance DS1 is defined between a center 1050C of the first deformation portion 1050 and the first flexible portion surface FS1.

Similarly, when viewed along the first axis AX1, a second distance DS2 is defined between the center 1050C of the first deformation portion 1050 and the second flexible portion surface FS2. The first distance DS1 and the second distance DS2 may have a first ratio, and the first ratio is not equal to one.

For example, the first distance DS1 may be 1.05 mm, and the second distance DS2 may be 0.45 mm, but they are not limited thereto. Therefore, the first ratio is, for example, 2.3333, but it is not limited thereto.

Next, as shown in FIG. 5 and FIG. 7, the first flexible portion 1043 has a third flexible portion surface FS3 and a fourth flexible portion surface FS4, the third flexible portion surface FS3 and the fourth flexible portion Surface FS4 are perpendicular to the first flexible portion surface FS1, and the fourth flexible portion surface FS4 and the third flexible portion surface FS3 face opposite directions.

The first flexible portion 1043 further has two third notch NT3 and a fourth notch NT4. The third notch NT3 is formed on the third flexible portion surface FS3, and the fourth notch NT4 is formed on the fourth flexible portion surface FS4.

As shown in FIG. 5, when viewed along the third axis AX3, one of the third notches NT3 (the lower one) overlaps the fourth notch NT4. Along the third axis AX3, the depth of the third notch NT3 is different from the depth of the fourth notch NT4, and the concave center line NL3 of the third notch NT3 extends along the third axis AX3, while the concave center line NL4 of the fourth notch NT4 does not extend along any one of the first axis AX1, the second axis AX2 and the third axis AX3. It should be noted that, to illustrate clearly, the concave center lines NL3 and NL4 are marked on the third notch NT3 and fourth notch NT4 of the second flexible portion 1044, and the concave center lines NL3 and NL4 of the second flexible portion 1044 are symmetrical to the concave center lines of the third notch NT3 and the fourth notch NT4 of the first flexible portion 1043.

As shown in FIG. 5, along the third axis AX3, the maximum size of a third gap GP3 between the third flexible portion surface FS3 and a third end portion NT31 of the third notch NT3 is different from the maximum size of a fourth gap GP4 between the fourth flexible portion surface FS4 and a fourth end portion NT41 of the fourth notch NT4.

For example, in this embodiment, as shown in FIG. 5, along the third axis AX3, the maximum size of the third gap GP3 is greater than the maximum size of the fourth gap GP4, but they are not limited thereto.

In this embodiment, the third notch NT3 may have a third arc surface CF3, the fourth notch NT4 may have a fourth arc surface CF4, and the radius of curvature of the third arc surface CF3 is different from the radius of curvature of the fourth arc surface CF4.

For example, the radius of curvature of the third arc surface CF3 is less than the radius of curvature of the fourth arc surface CF4, and the shortest distance between the third arc surface CF3 and the driving portion 116 is greater than the shortest distance between the fourth arc surface CF4 and the driving portion 116.

Similarly, the first flexible portion 1043 may have a second deformation portion 1052 which is adjacent to the third notch NT3, and the second deformation portion 1052 is also adjacent to the fourth notch NT4. Specifically, the second deformation portion 1052 is a flexible portion of the driving body 104, which is located between the third notch NT3 and the fourth notch NT4.

As shown in FIG. 5, when viewed along the second axis AX2, a third distance DS3 is defined between a center 1052C of the second deformation portion 1052 and the third flexible portion surface FS3, and the center 1052C of the second deformation portion 1052 is the center of the shortest distance between the third notch NT3 and the fourth notch NT4.

Similarly, when viewed along the second axis AX2, a fourth distance DS4 is defined between the center 1052C of the second deformation portion 1052 and the fourth flexible portion surface FS4. The third distance DS3 and the fourth distance DS4 have a second ratio, and the second ratio is not equal to one.

For example, the third distance DS3 may be 0.65 mm, and the fourth distance DS4 may be 0.45 mm, but they are not limited thereto. Therefore, the second ratio is, for example, 1.444, but it is not limited thereto.

Similarly, as shown in FIG. 4 and FIG. 5, the first flexible portion 1043 has a fifth flexible portion surface FS5, the fifth flexible portion surface FS5 is perpendicular to the first flexible portion surface FS1, and the fifth flexible portion surface FS5 and the first connecting surface 1047 face opposite directions.

The first flexible portion 1043 further has a fifth notch NT5 and a sixth notch NT6. The fifth notch NT5 is formed on the fifth flexible portion surface FS5, and the sixth notch NT6 is formed on the fourth flexible portion surface FS4.

When viewed along the first axis AX1, the fifth notch NT5 overlaps at least a portion of the sixth notch NT6. Along the first axis AX1, the depth of the fifth notch NT5 is different from the depth of the sixth notch NT6, and the concave center line NL5 of the fifth notch NT5 extends along the first axis AX1, while the concave center line NL6 of the sixth notch NT6 does not extend along any one of the first axis AX1, the second axis AX2 and the third axis AX3. It should be noted that, to illustrate clearly, the concave center lines NL5 and NL6 are marked on the fifth notch NT5 and sixth notch NT6 of the second flexible portion 1044, and the concave center lines NL5 and NL6 of the second flexible portion 1044 are symmetrical to the concave center lines of the fifth notch NT5 and the sixth notch NT6 of the first flexible portion 1043.

As shown in FIG. 5, along the first axis AX1, the maximum size of a fifth gap GP5 between the fifth flexible portion surface FS5 and a fifth end portion NT51 of the fifth notch NT5 is different from the maximum size of a sixth gap GP6 between the first connecting surface 1047 and a sixth end portion NT61 of the sixth notch NT6.

For example, in this embodiment, as shown in FIG. 5, along the first axis AX1, the maximum size of the fifth gap GP5 is greater than the maximum size of the sixth gap GP6, but they are not limited thereto.

In this embodiment, the fifth notch NT5 has a fifth arc surface CF5, the sixth notch NT6 has a sixth arc surface CF6, and the radius of curvature of the fifth arc surface CF5 is different from the radius of curvature of the sixth arc surface CF6.

For example, the radius of curvature of the fifth arc surface CF5 is less than the radius of curvature of the sixth arc surface CF6, and the shortest distance between the fifth arc surface CF5 and the driving portion 116 is greater than the shortest distance between the sixth arc surface CF6 and the driving portion 116.

It is worth noting that, as shown in FIG. 5, the sixth arc surface CF6 may have a first arc surface portion CF61 and a second arc surface portion CF62, the first arc surface portion CF61 faces the third arc surface CF3, while the second arc surface portion CF62 faces the fifth arc surface CF5.

The first arc surface portion CF61 and the second arc surface portion CF62 are integrally formed as one piece. Based on the above structural configuration, the movable portion 1041 can easily deform together with the first flexible portion 1043 to move relative to the fixed portion 1042.

Similarly, the first flexible portion 1043 further has a third deformation portion 1053 which is adjacent to the fifth notch NT5, and the third deformation portion 1053 is also adjacent to the sixth notch NT6. Specifically, the third deformation portion 1053 is a flexible portion of the driving body 104, which is located between the fifth notch NT5 and the sixth notch NT6.

As shown in FIG. 5, when viewed along the second axis AX2, a fifth distance DS5 is defined between a center 1053C of the third deformation portion 1053 and the fifth flexible portion surface FS5, and the center 1053C of the third deformation portion 1053 is the center of the shortest distance between the fifth notch NT5 and the sixth notch NT6.

Similarly, when viewed along the second axis AX2, a sixth distance DS6 is defined between a center of the third deformation portion 1053 and the first connecting surface 1047. The fifth distance DS5 and the sixth distance DS6 have a third ratio, and the third ratio is not equal to one.

For example, the fifth distance DS5 may be 0.775 mm, and the sixth distance DS6 may be 0.475 mm, but they are not limited thereto. Therefore, the second ratio is, for example, 1.6315, but it is not limited thereto.

In addition, it is worth explaining that, as shown in FIG. 5, the sixth notch NT6 is symmetrical to the fourth notch NT4, and the first notch NT1, the fourth notch NT4, the fifth notch NT5 and the sixth notch NT6 are integrally formed as one piece. Based on this configuration, the driving body 104 can have sufficient structural strength and also have flexibility at the same time.

Furthermore, as shown in FIG. 5, when viewed along the second axis AX2, the first flexible portion 1043 has a rectangular structure, and a longitudinal axis LX1 of the rectangular structure is parallel to the first axis AX1.

In addition, the first flexible portion 1043 further has a notch portion 104R1, which is disposed at a corner of the rectangular structure (such as the upper left corner in FIG. 5), and when viewed along the second axis AX2, the fifth notch NT5 is located between the notch portion 104R1 and the movable portion 1041. Similarly, the second flexible portion 1044 may also have another notch portion 104R2, and the notch portion 104R2 is symmetrical to the notch portion 104R1.

Based on the design of the notch portion 104R1 and the notch portion 104R2, the driving body 104 can be flexible while also reducing the overall weight so as to achieve the purpose of lightweighting.

Based on the design of these notches on the first flexible portion 1043 and the second flexible portion 1044, when the driving portion 116 deforms (expanses or contracts), it will drive the first flexible portion 1043, the second flexible portion 1044 and the movable portion 1041 to deform, so that the movable portion 1041 drives the contact member 105 to move.

Therefore, the driving portion 116 is configured to drive the movable portion 1041 and the contact member 105 to move in a first dimension, and the movement in the first dimension includes the movement along the first axis AX1 and the second axis AX2. The specific action manner and range of motion will be described in the following paragraphs.

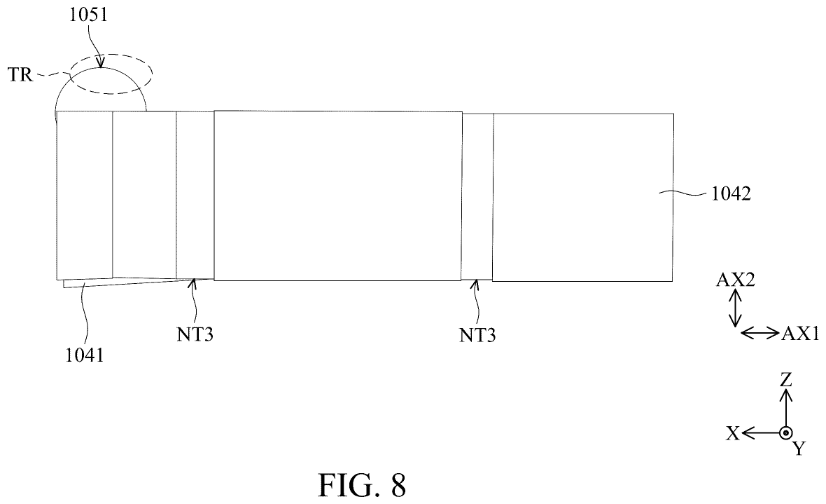

Please refer to FIG. 7 and FIG. 8 to FIG. 10. FIG. 8 to FIG. 10 are side views illustrating that the driving body 104 deforms to drive the contact member 105 to move and located in different positions according to an embodiment of the present disclosure. In this embodiment, the driving portion 116 is configured to receive a first control signal CS1 and a second control signal CS2 from an external control circuit thorough lead wires WR1 and WR2 (FIG. 4) to generate deformation. The external control circuit is, for example, a control chip or a control integrated circuit, but it is not limited thereto.

After receiving the above control signal, the driving portion 116 deforms according to the first control signal CS1 or the second control signal CS2 to push the movable portion 1041, so that the first flexible portion 1043, the second flexible portion 1044 and the movable portion 1041 deform to drive the contact member 105 to move relative to the fixed portion 1042. That is, the fixed portion 1042 does not deform.

The first control signal CS1 and the second control signal CS2 have periodic characteristics, and the frequency of the first control signal CS1 is the same as the frequency of the second control signal CS2. For example, the first control signal CS1 and the second control signal CS2 may be AC square wave signals and have the same frequency, but they are not limited thereto. It is worth noting that in this embodiment, the phase difference between the first control signal CS1 and the second control signal CS2 is 180 degrees.

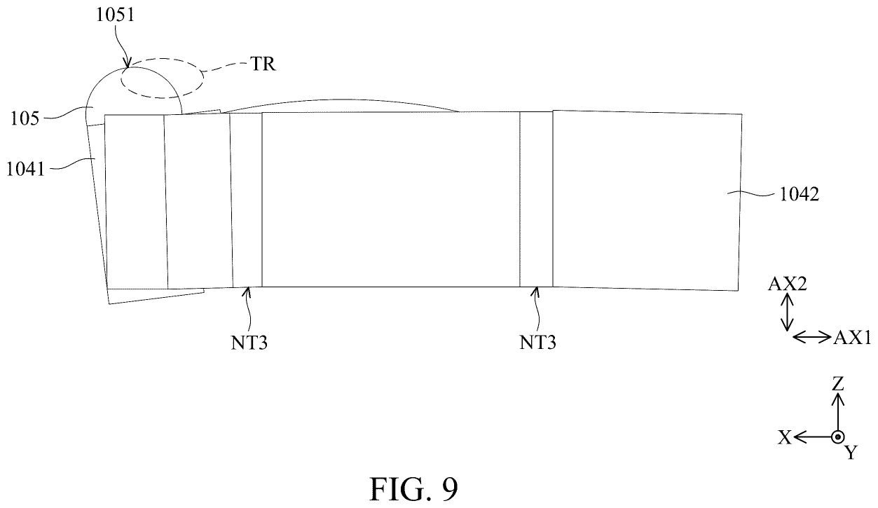

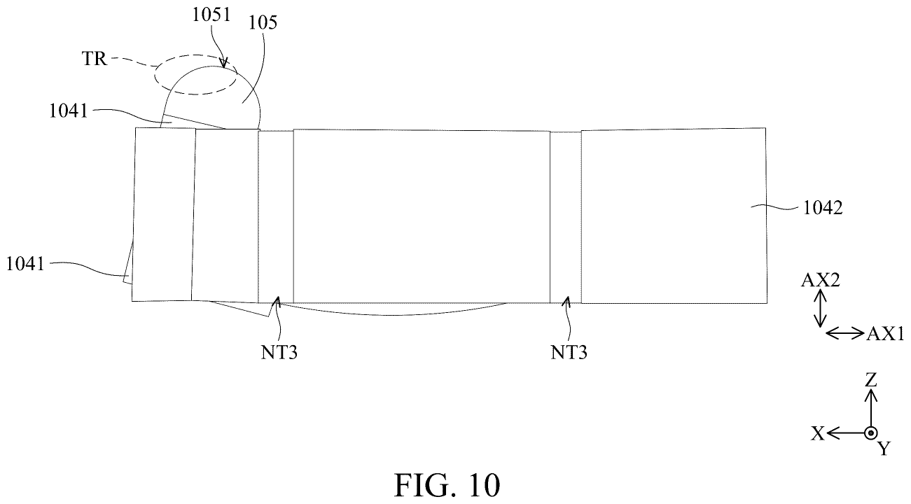

As shown in FIG. 7, FIG. 8 to FIG. 10, when the driving portion 116 receives the first control signal CS1 (for example, the initial phase is 0 degrees), the driving portion 116 will first expand and then contract, to drive the movable portion 1041 to deform, so that the contact member 105 rotates sequentially from the position in FIG. 7 to the positions in FIG. 8, FIG. 9 and FIG. 10, and then returns to the position in FIG. 7.

That is, when the driving portion 116 drives the movable portion 1041 to move, the contact member 105 rotates clockwise, and the movement trajectory of the contact portion 1051 of the contact member 105 is an arc trajectory TR. As shown in FIG. 7, arc trajectory TR is, for example, an elliptical trajectory. The arc trajectory TR has a closed structure, and the arc trajectory TR has a center CC. As shown in FIG. 5 and FIG. 7, the arc trajectory TR defines a central axis CX, and the central axis CX passes through the center CC.

As shown in FIG. 5, the central axis CX is parallel to the third axis AX3, and the central axis CX is perpendicular to the second axis AX2. As shown in FIG. 7, when viewed along the first axis AX1 or the third axis AX3, the central axis CX does not pass through a center 116C of the driving portion 116.

In this embodiment, when the driving portion 116 of the driving assembly DA receives the first control signal CS1, the driving assembly DA drives the contact member 105 to move in the first dimension. That is, the movement of the contact member 105 in the first dimension is the clockwise movement of the contact member 105 along the arc trajectory TR in FIG. 7.

On the contrary, when the driving portion 116 of the driving assembly DA receives the second control signal CS2, the driving assembly DA drives the contact member 105 to move in a second dimension, and the second dimension is opposite to the first dimension. That is, the movement in the second dimension is the counterclockwise movement of the contact member 105 along the arc trajectory TR in FIG. 7.

That is, when the driving portion 116 receives the second control signal CS2 (for example, the initial phase is 180 degrees), the driving portion 116 will first contract and then expand to drive the movable portion 1041 to deform, so that the contact member 105 rotates sequentially from the position in FIG. 7 to the positions in FIG. 10, FIG. 9 and FIG. 8, and then returns to the position in FIG. 7.

In addition, it should be noted that in this embodiment, the frequency of the first control signal CS1 is the same as the frequency of the second control signal CS2, but it is not limited thereto. In other embodiments, the frequency of the first control signal CS1 and the frequency of the second control signal CS2 may be different, but the phase of the first control signal CS1 and the phase of the second control signal CS2 are the same.

For example, when the frequency of the first control signal CS1 is 120 kHz, the contact member 105 moves clockwise along the arc trajectory TR in FIG. 7. On the other hand, when the frequency of the second control signal CS2 is 130 kHz, the contact member 105 moves counterclockwise along the arc trajectory TR in FIG. 7, thereby achieving the purpose of driving the driven element to move in different directions at different speeds.

Based on the above various configurations of the first control signal CS1 and the second control signal CS2, different means can be used according to different application scenarios to control the movement of the contact member 105. That is, these configurations can increase the flexibility of use and can adapt to different usage environments or driven elements.

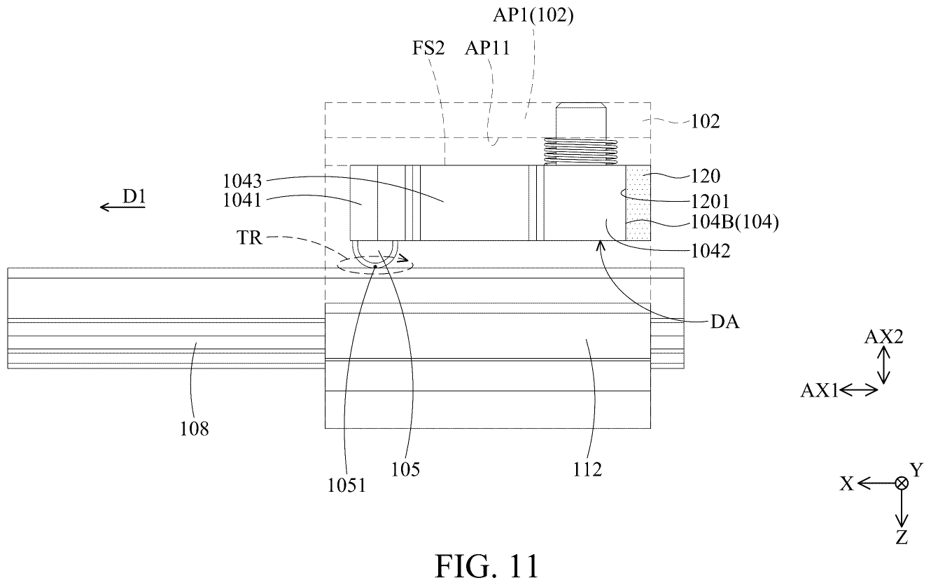

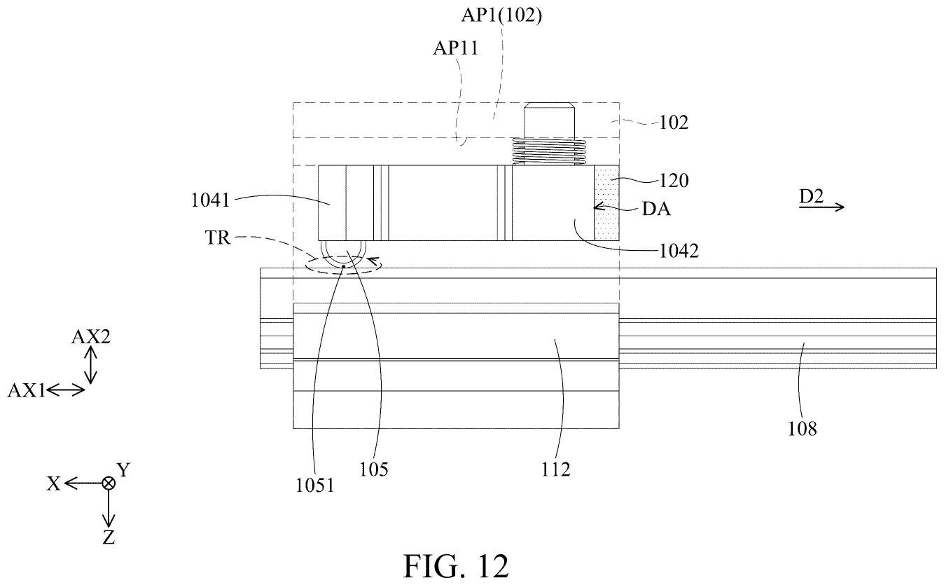

Next, please refer to FIG. 11 to FIG. 12. FIG. 11 is a schematic diagram illustrating that the driving assembly DA drives the movable member 108 to move in a first direction D1 according to an embodiment of the present disclosure, and FIG. 12 is a schematic diagram illustrating that the driving assembly DA drives the movable member 108 to move in a second direction D2 according to an embodiment of the present disclosure.

As shown in FIG. 11, when the contact member 105 is driven by the movable portion 1041 to rotate clockwise, the contact portion 1051 of the contact member 105 switches between a detached state and a contact state. For example, when the contact portion 1051 is located at the upper portion of the arc trajectory TR in FIG. 11, the contact member 105 does not contact the movable member 108 and is in the detached state. On the other hand, when the contact portion 1051 is located at the lower portion of the arc trajectory TR, the contact member 105 is in contact with the movable member 108 and in the contact state, so as to push the movable member 108.

As shown in FIG. 11, when the contact member 105 rapidly rotates clockwise and repeatedly contacts the movable member 108, the movable member 108 can move in the first direction D1. On the other hand, as shown in FIG. 12, when the contact member 105 rapidly rotates counterclockwise and repeatedly contacts the movable member 108, the movable member 108 can move in the second direction D2.

In order to ensure that the movable portion 1041 is not in contact with the outer casing 102 during movement, in this embodiment, the outer casing 102 of the fixed assembly FA may include an avoiding portion API (the top), which corresponds to the second flexible portion surface FS2 of the first flexible portion 1043. The avoiding portion API may have an avoiding surface AP11 which faces the second flexible portion surface FS2.

Along the second axis AX2, there is a gap between the avoiding surface AP11 and the second flexible portion surface FS2, so that it can avoid the problem that the movable portion 1041 collides with the avoiding surface AP11 of the outer casing 102 during movement, thereby causing damage to the movable portion 1041.

Furthermore, in order to ensure that when the movable portion 1041 moves, the fixed portion 1042 can be located on the aforementioned fixed position without moving, the driving mechanism 100 can further include a limiting element 120, fixedly connected to the outer casing 102 and located within the outer casing 102. The limiting element 120 is, for example, a cube, which can be integrally formed with the outer casing 102, but they are not limited thereto.

As shown in FIG. 11, the limiting element 120 may have a limiting surface 1201 which faces the driving assembly DA. The limiting surface 1201 is parallel to the second axis AX2 (the Z-axis) and perpendicular to the first axis AX1, and the limiting surface 1201 is in direct contact with a fixed surface 104B of the driving body 104 of the driving assembly DA.

Based on the configuration of the limiting element 120, the driving assembly DA will be fixed on the aforementioned fixed position without rotating around the second axis AX2 so as to ensure that the contact member 105 can effectively drive the movable member 108 to move in the first direction D1 or the second direction.

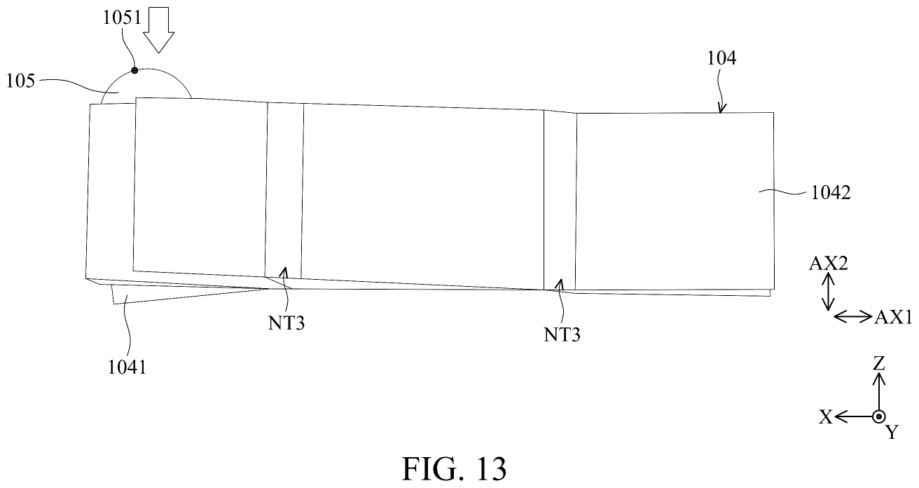

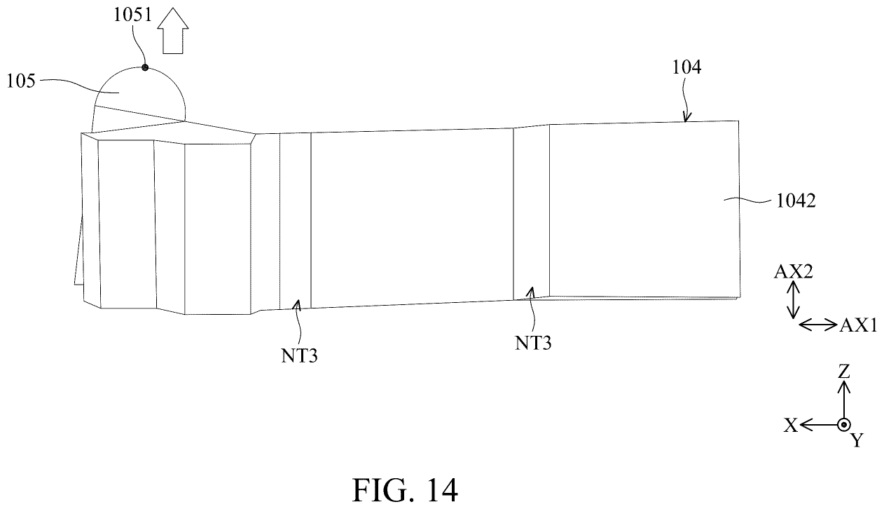

Next, please refer to FIG. 13 and FIG. 14. FIG. 13 and FIG. 14 are side views illustrating that the movable portion 1041 drives the contact member 105 to be located in different positions according to another embodiment of the present disclosure. In this embodiment, the driving body 104 can make the depths of the third notch NT3 to the sixth notch NT6 to be much smaller than the depths of the first notch NT1 and the second notch NT2, such as be 1/5 to 1/10 of other notches.

Based on this configuration, the driving body 104 will repeatedly switch between the first deformation state in FIG. 13 and the second deformation state in FIG. 14, so that the movable portion 1041 can drive the contact member 105 to moves back and forth along the second axis AX2.

Based on this driving method, the driving assembly DA can quickly touch or provide vibration to an object. For example, the driving assembly DA can provide vibration to the liquid so as to achieve the function of ultrasonic cleaning.

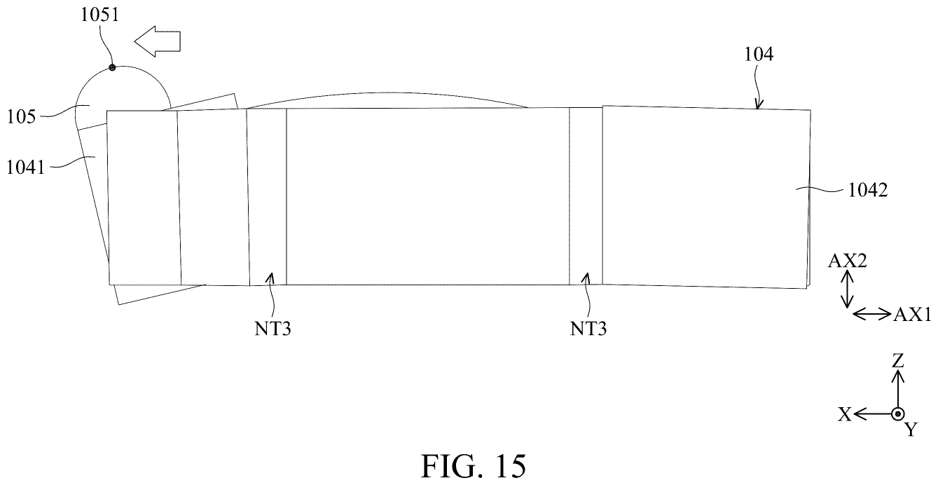

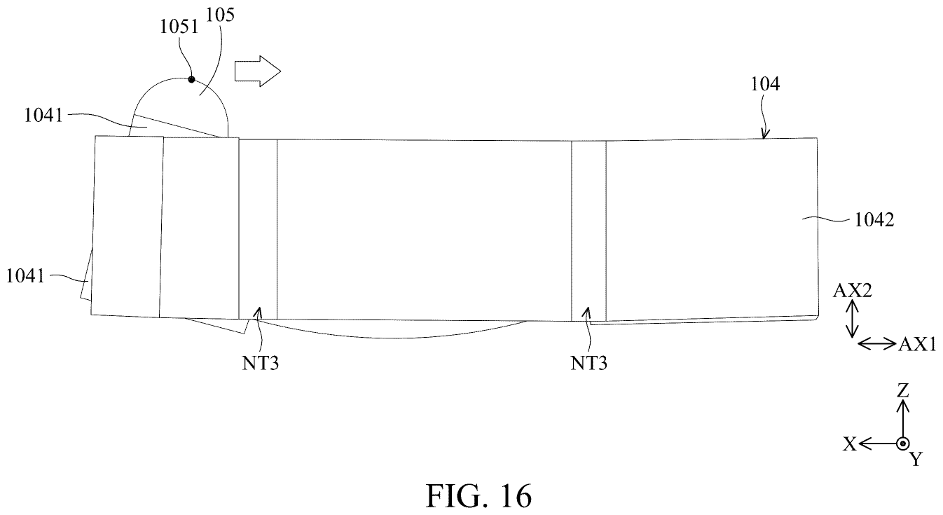

Next, please refer to FIG. 15 and FIG. 16. FIG. 15 and FIG. 16 are side views illustrating that the movable portion 1041 drives the contact member 105 to be located in different positions according to another embodiment of the present disclosure. In this embodiment, the driving body 104 can make the depths of the first notch NT1 and the second notch NT2 to be much smaller than the depths of other notches, for example, 1/5 to 1/10 of the other notches.

Based on this configuration, the driving body 104 will repeatedly switch between the third deformation state in FIG. 15 and the fourth deformation state in FIG. 16, so that the movable portion 1041 can drive the contact member 105 to move back and forth along the first axis AX1. Based on this driving method, the driving assembly DA can drive an object to move back and forth along the first axis AX1.

In conclusion, the present disclosure provides a driving mechanism 100, which includes a fixed assembly FA, a movable member 108 and a driving assembly DA. The driving assembly DA is configured to drive the movable member 108 to move relative to the fixed assembly FA. The driving assembly DA may include a driving body 104 and a driving portion 116. The driving portion 116 can receive external control signals and then deforms to push the driving body 104 to deform, thereby driving the contact member 105 located on the movable portion 1041 to move in the first dimension or the second dimension. When the contact member 105 moves, the contact member 105 will repeatedly contact the movable member 108, thereby driving the movable member 108 to move, such as moving in the first direction D1 or the second direction D2.

In some embodiments, the driving portion 116 can drive the contact member 105 to move clockwise or counterclockwise along an arc trajectory TR according to different control signals. Based on such a design, the driving member 105 can quickly drive the movable member 108 to move back and forth along the first axis AX1, and the displacement accuracy can be greatly improved in contrast to a traditional motor. In addition, in other embodiments, by adjusting the configuration of the notches on the driving body 104, the driving portion 116 can drive the contact member 105 to move along the first axis AX1 or the second axis AX2, thereby achieving different application purposes.

In addition, because the driving mechanism of the present disclosure does not require traditional coils, magnets and additional pushing elements, the overall volume of the driving mechanism 100 can be effectively reduced to achieve the purpose of miniaturization, and because the driving portion 116 is the piezoelectric element, it can provide a greater driving force than the traditional coil motor, so as to push a larger and heavier object.

Although the embodiments and their advantages have been described in detail, it should be understood that various changes, substitutions, and alterations can be made herein without departing from the spirit and scope of the embodiments as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein can be utilized according to the disclosure. Accordingly, the appended claims are intended to include within their scope such processes, machines, manufacture, compositions of matter, means, methods, or steps. In addition, each claim constitutes a separate embodiment, and the combination of various claims and embodiments are within the scope of the disclosure.

What is claimed is:

1. A driving mechanism, comprising:
a fixed portion;
a movable portion, movable relative to the fixed portion; and
a driving portion, configured to drive the movable portion to move relative to the fixed portion,
wherein the movable portion and the driving portion are arranged along a first axis.

2. The driving mechanism as claimed in claim 1, wherein
the driving mechanism further includes a contact member which is disposed on the movable portion;
the contact member has a contact portion, configured to contact a driven element;
the driving mechanism further includes a first flexible portion and a first connecting portion;
the movable portion is movably connected to the fixed portion via the first flexible portion;
the first connecting portion is connected to the driving portion, and the first connecting portion has a first connecting surface which faces the driving portion; and
the driving portion has a first surface which faces the first connecting portion and is connected to the first connecting surface.

3. The driving mechanism as claimed in claim 2, wherein
the driving mechanism further includes a second connecting portion which is connected to the driving portion, and the second connecting portion has a second connecting surface which faces the driving portion;
the driving portion has a second surface which faces the second connecting portion and is connected to the second connecting surface;
the first connecting surface is perpendicular to the first axis;
when viewed along a second axis, the first flexible portion does not overlap the driving portion; and
the first axis and the second axis are perpendicular to each other.

4. The driving mechanism as claimed in claim 3, wherein
the first flexible portion and the driving portion are arranged along a third axis;
the third axis, the first axis and the second axis are perpendicular to each other;
the driving portion is configured to drive the movable portion to move in a first dimension, and movement in the first dimension at least includes movement along the second axis; and
when the driving portion drives the movable portion to move, a movement trajectory of the contact portion is an arc trajectory.

5. The driving mechanism as claimed in claim 4, wherein
the arc trajectory has a closed structure;
the arc trajectory has a center;
the arc trajectory defines a central axis that passes through the center;
the central axis is parallel to the third axis;
the central axis is perpendicular to the second axis; and
when viewed along the first axis or the third axis, the central axis does not pass through a center of the driving portion.

6. The driving mechanism as claimed in claim 5, wherein
the first flexible portion has a first flexible portion surface and a second flexible portion surface;
the first flexible portion surface and the second flexible portion surface face opposite directions;
the first flexible portion further has a first notch and a second notch;
the first notch is formed on the first flexible portion surface; and
the second notch is formed on the second flexible portion surface.

7. The driving mechanism as claimed in claim 6, wherein
when viewed along the second axis, the first notch overlaps at least a portion of the second notch; and
a depth of the first notch is different from a depth of the second notch.

8. The driving mechanism as claimed in claim 7, wherein
along the second axis, a maximum size of a first gap between the first flexible portion surface and a first end portion of the first notch is different from a maximum size of a second gap between the second flexible portion surface and a second end portion of the second notch;
along the second axis, the maximum size of the first gap is greater than the maximum size of the second gap; and
when viewed along the first axis or the third axis, the center of the driving portion is located between the second flexible portion surface and the contact portion.

9. The driving mechanism as claimed in claim 8, wherein
the first flexible portion further has a first deformation portion which is adjacent to the first notch;
the first deformation portion is adjacent to the second notch; and
the first deformation portion is located between the first notch and the second notch.

10. The driving mechanism as claimed in claim 9, wherein
when viewed along the first axis, a first distance is defined between a center of the first deformation portion and the first flexible portion surface;
when viewed along the first axis, a second distance is defined between a center of the first deformation portion and the second flexible portion surface;
the first distance and the second distance have a first ratio; and
the first ratio is not equal to one.

11. The driving mechanism as claimed in claim 10, wherein
the first flexible portion further has a third flexible portion surface and a fourth flexible portion surface;
the third flexible portion surface is perpendicular to the first flexible portion surface;
the fourth flexible portion surface and the third flexible portion surface face opposite directions;
the first flexible portion further has a third notch and a fourth notch;
the third notch is formed on the third flexible portion surface; and
the fourth notch is formed on the fourth flexible portion surface.

12. The driving mechanism as claimed in claim 11, wherein
when viewed along the third axis, the third notch overlaps the fourth notch;
a depth of the third notch is different from a depth of the fourth notch;
a concave center line of the third notch extends along the third axis, and a concave center line of the fourth notch does not extend along any one of the first axis, the second axis and the third axis.

13. The driving mechanism as claimed in claim 12, wherein
along the third axis, a maximum size of a third gap between the third flexible portion surface and a third end portion of the third notch is different from a maximum size of a fourth gap between the fourth flexible portion surface and a fourth end portion of the fourth notch;
along the third axis, the maximum size of the third gap is greater than the maximum size of the fourth gap.

14. The driving mechanism as claimed in claim 13, wherein
the third notch has a third arc surface;
the fourth notch has a fourth arc surface;
a radius of curvature of the third arc surface is different from a radius of curvature of the fourth arc surface;
the radius of curvature of the third arc surface is less than the radius of curvature of the fourth arc surface; and
a shortest distance between the third arc surface and the driving portion is greater than a shortest distance between the fourth arc surface and the driving portion.

15. The driving mechanism as claimed in claim 14, wherein
the first flexible portion has a second deformation portion which is adjacent to the third notch;
the second deformation portion is adjacent to the fourth notch;
the second deformation portion is located between the third notch and the fourth notch;
when viewed along the second axis, a third distance is defined between a center of the second deformation portion and the third flexible portion surface;
when viewed along the second axis, a fourth distance is defined between the center of the second deformation portion and the fourth flexible portion surface;
the third distance and the fourth distance have a second ratio; and
the second ratio is not equal to one.

16. The driving mechanism as claimed in claim 15, wherein
the first flexible portion has a fifth flexible portion surface;
the fifth flexible portion surface is perpendicular to the first flexible portion surface;
the fifth flexible portion surface and the first connecting surface face opposite directions;
the first flexible portion has a fifth notch and a sixth notch;
the fifth notch is formed on the fifth flexible portion surface; and
the sixth notch is formed on the fourth flexible portion surface.

17. The driving mechanism as claimed in claim 16, wherein
when viewed along the first axis, the fifth notch overlaps at least a portion of the sixth notch;
a depth of the fifth notch is different from a depth of the sixth notch;
along the first axis, a maximum size of a fifth gap between the fifth flexible portion surface and a fifth end portion of the fifth notch is different from a maximum size of a sixth gap between the first connecting surface and a sixth end portion of the sixth notch; and
along the first axis, the maximum size of the fifth gap is greater than the maximum size of the sixth gap.

18. The driving mechanism as claimed in claim 17, wherein
the fifth notch has a fifth arc surface;
the sixth notch has a sixth arc surface;
a radius of curvature of the fifth arc surface is different from a radius of curvature of the sixth arc surface;
the radius of curvature of the fifth arc surface is less than the radius of curvature of the sixth arc surface; and
a shortest distance between the fifth arc surface and the driving portion is greater than a shortest distance between the sixth arc surface and the driving portion.

19. The driving mechanism as claimed in claim 18, wherein
the sixth arc surface has a first arc surface portion and a second arc surface portion;
the first arc surface portion faces the third arc surface;
the second arc surface portion faces the fifth arc surface;
the first arc surface portion and the second arc surface portion are integrally formed as one piece;
the first flexible portion has a third deformation portion which is adjacent to the fifth notch;
the third deformation portion is adjacent to the sixth notch;
the third deformation portion is located between the fifth notch and the sixth notch;
when viewed along the second axis, a fifth distance is defined between a center of the third deformation portion and the fifth flexible portion surface;
when viewed along the second axis, a sixth distance is defined between a center of the third deformation portion and the first connecting surface;
the fifth distance and the sixth distance have a third ratio; and
the third ratio is not equal to one.

20. The driving mechanism as claimed in claim 19, wherein
the sixth notch is symmetrical to the fourth notch;
the first notch, the fourth notch, the fifth notch and the sixth notch are integrally formed as one piece;
when viewed along the second axis, the first flexible portion has a rectangular structure;
a longitudinal axis of the rectangular structure is parallel to the first axis;
the first flexible portion further has a notch portion, which is disposed at a corner of the rectangular structure; and
when viewed along the second axis, the fifth notch is located between the notch portion and the movable portion.
